(19) United States
(12) Patent Application Publication
(10) Pub. No.: US 2002/0127363 A1
(43) Pub. Date: Sep. 12, 2002

(54) Display apparatus

(75) Inventors: Koichi Kaneko, Shizuoka-ken (JP); Toshiharu Oishi, Shizuoka-ken (JP); Masaru Nozawa, Shizuoka-ken (JP); Sadao Yokoi, Shizuoka-ken (JP); Masahiko Kakihara, Shizuoka-ken (JP); Yukiharu Miyamura, Shizuoka-ken (JP); Kazuhiro Ohnuma, Shizuoka-ken (JP)

Correspondence Address: ARENT FOX KINTNER PLOTKIN & KAHN, PLLC, Suite 600, 1050 Connecticut Avenue, N.W., Washington, DC, 20036-5339, US

(73) Assignee: Pioneer Corporation

(21) Appl. No.: 10/092,464

(22) Filed: Mar. 8, 2002

(30) Foreign Application Priority Data
Mar. 9, 2001 (JP) 2001-67279

(51) Int. Cl. B32B 9/00; B32B 33/00

(52) U.S. Cl. 428/40.1

(57) ABSTRACT

An effortless peeling operation is provided with maintaining the adhesion area required between a display panel and a chassis, which allows a disassembling operation for recycling and a parts replacement operation to be simplified. A plasma display apparatus includes a plurality of double-faced adhesive tapes 50 interposed between and adhering to the back surface of a display panel 1 and a chassis 3 for attaching the chassis 3 to the display panel 1. The double-faced adhesive tape 50 used has an adhesive strength smaller than a peel force produced by strain in a width direction caused by tension in a longitudinal direction, and the tape 50 is pulled in the longitudinal direction for peeling.

### BACKGROUND OF THE INVENTION

1. Field of the Invention

This invention relates to a display apparatus employing a plasma display panel, a field emission display (FED) panel or the like. More particularly, it relates to a display apparatus in which a fixation between a display panel and a chassis has been improved so that the two elements can be easily separated from each other when the apparatus is discarded for recycling.

The present application claims priority from Japanese Application No. 2001-67279, the disclosure of which is incorporated herein by reference for all purposes.

2. Description of the Related Art

A known display apparatus includes a plasma display panel (hereinafter referred to as “PDP”) comprising row electrode pairs and column electrodes which are arranged on the respective inner surfaces of a pair of substrates, disposed opposite to each other with a discharge space formed between, so as to form a discharge cell at each intersection of a row electrode pair and a column electrode, thereby effecting an electric discharge in each discharge cell and thus effecting a desired displaying.

A display apparatus employing such a PDP includes a chassis which is provided on the back side of the PDP within the display apparatus for supporting the substrates of the PDP and supporting a circuit board having a driving circuit for driving the PDP. The chassis is required to have a function for dissipating the heat generated in the PDP to cool the PDP substrates as well as the above function of serving as a supporting member.

FIG. 3 and FIG. 4 are explanatory diagrams for schematically illustrating the construction of a conventional display apparatus, FIG. 3 showing a side view and FIG. 4 showing a plan view. In FIGS. 3 and 4, a PDP 1 is constructed by bonding a front glass substrate 1A and a back glass substrate 1B together around a discharge space 1C. A circuit board 2 for driving the PDP 1 is mounted to the PDP 1 through a chassis 3.

The chassis 3 is a plate-shaped member made of a metal having a high thermal conductivity, such as aluminum. The PDP 1 is electrically connected to the circuit board 2 through a flexible cable 4, and also is secured to the chassis 3 by a double-faced adhesive tape 5 adhering to the outside surface of the back glass substrate 1B of the PDP 1 (on the back surface of the PDP 1) as illustrated in FIG. 4.

In recent years, a reduction in industrial waste has been required because of the increasing awareness of global environmental issues. Particularly, regarding various types of household electrical appliances, the recycling has been tackled by way of collecting and disassembling the used products to turn the glass and metal parts back into reusable materials. For display apparatuses, one possible idea for recycling is a way of separating the display panel made up of glass substrates from the chassis made of a metal such as aluminum. However, in order to peel off the double-faced adhesive tape, the aforementioned conventional construction needs a special peeling method using solvents, heating, water pressure or the like, leading to the problem of an increase in cost. Further, when a display panel has a defect while still on a production line or needs to be repaired after the shipment of product, the aforementioned conventional construction has been proved difficult to separate the display panel from the chassis, leading to a problem that defect parts can not be easily replaced.

In view of the above, one idea for improvement is to reduce the adhesion area of the double-faced adhesive tape for smooth peeling. In this case, however, a gap is likely to occur between the display panel and chassis, which causes another problem that an amount of heat transferred from the display panel to the chassis will be undesirably reduced. Further, if the adhesion area is reduced, a temperature difference may occur between an adhesion part and a non-adhesion part, thus causing a thermal stress strains on the display panel, leading to the problem of the display characteristics being affected by the thermal stress strain.

### SUMMARY OF THE INVENTION

The present invention has been made to solve such problems, and therefore an object of the present invention is to provide a display apparatus capable of facilitating a peeling operation while maintaining an adhesion area required between a display panel and a chassis, and of simplifying a disassembling process for recycling and a parts replacing process.

To attain the above object, a display apparatus according to the present invention is equipped with the following features.

In a first aspect of the present invention, the display apparatus has the feature of including a display panel, a chassis, and a plurality of double-faced adhesive tapes interposed between and adhering to the back surface of the display panel and the chassis for attaching the chassis to the display panel, and each having an adhesive strength smaller than a peel force produced by a strain in its width direction which is caused by a tension in its longitudinal direction.

In a second aspect of the present invention, based on a display apparatus according to the above first aspect, the double-faced adhesive tape has a shear adhesive strength of smaller than or equal to 60 N/cm².

In a third aspect of the present invention, based on a display apparatus according to the aforementioned first aspect, the double-faced adhesive tape consists of a base material having a breaking elongation rate of more than or equal to 300 percent.

In a fourth aspect of the present invention, based on a display apparatus according to the aforementioned first aspect, the double-faced adhesive tape has an end protruding outwardly beyond ends of both the display panel and the chassis or beyond an end of one of the display panel and the chassis.

The present invention having the above features yields the following operation and effects. In order to achieve a construction allowing smooth peeling in addition to ensuring an adequate adhesion area and adhesive strength, the construction can use a plurality of double-faced adhesive tapes to ensure a required adhesion area and adhesive strength equal to that of the sum total of the double-faced adhesive tapes and allows the tapes to be individually peeled in the peeling operation. With this point in mind, the present invention has a parallel arrangement of a plurality of double-faced adhesive tapes having a predetermined width in the width direction. Each of the arranged double-faced adhesive tapes can be pulled individually in the longitudinal direction to produce strain in the width direction, and the produced strain produces a peel force allowing each double-faced adhesive tape to be individually peeled off from its originally bonded position.

More specifically, a base material of the double-faced adhesive tape consists of materials having a high elasticity. When the double-faced adhesive tape is pulled in the longitudinal direction, the base material contracts in the width direction by the amount of strain resulting from “the strain in the longitudinal direction×Poisson's ratio”. The strain in the width direction produces a peel force (shear force) which is utilized for peeling the double-faced adhesive tape adhering between the display panel and the chassis. In other words, in the situation where a plurality of double-faced adhesive tapes are interposed between the back surface of the display panel and the chassis for adhesion, when an end of one of the double-faced adhesive tapes is pulled in the longitudinal direction, the tape is extended in the longitudinal direction and concurrently undergoes contraction in the width direction (or in the thickness direction) in proportion to the extension, and the resulting strain causes a peel force on the adhesion portion. The peel force (shear force) at this point takes a value formed by multiplying the strain in the width direction by Young's modulus (modulus of lateral elasticity) of the double-faced adhesive tape. If in relation to the peel force, the sum total (shear adhesive strength) of an adhesive strength between one adhering face of the double-faced adhesive tape and the back surface of the display panel and an adhesive strength between the other adhering face of the double-faced adhesive tape and the mating face of the chassis, is set to be lower, then the double-faced adhesive tape can be peeled only by being pulled as described above. In practical terms, when the shear adhesive strength of the double-faced adhesive tape stands at equal to or smaller than about 60 N/cm², this allows the tape to be peeled.

When the base material of the double-faced adhesive tape has a tensile strength higher than a tensile force required for peeling, it is possible to pull out the tape without breaking it. In practical terms, when the double-faced adhesive tape has a breaking elongation rate of more than or equal to 300 percent (i.e. the tape has such a strength as not to be broken even when the base material elongates three times or more its original length), the tape can be pulled out from between the display panel and the chassis.

Further, each of the double-faced adhesive tapes is disposed such that its end protrudes outwardly beyond ends of both the display panel and the chassis or beyond an end of one of those. This design facilitates pulling the end of the double-faced adhesive tape in the situation where a plurality of the double-faced adhesive tapes are interposed between the back surface of the display panel and the chassis for attaching the display panel to the chassis.

These and other objects and features of the present invention will become more apparent from the following detailed description with reference to the accompanying drawings.

### BRIEF DESCRIPTION OF THE DRAWINGS

FIG. 1 is an explanatory diagram (a plan view) illustrating a preferred embodiment of the present invention.

FIGS. 2A and 2B are explanatory diagrams (side views) illustrating the embodiment of the present invention.

FIG. 3 is an explanatory diagram illustrating a conventional display apparatus.

FIG. 4 is an explanatory diagram illustrating the conventional display apparatus.

### DETAILED DESCRIPTION OF THE PREFERRED EMBODIMENT

A preferred embodiment according to the present invention will be described hereinafter with reference to the accompanying drawings (the same components as those of the prior art are designated by the same reference numerals and the repeated part of the description is omitted).

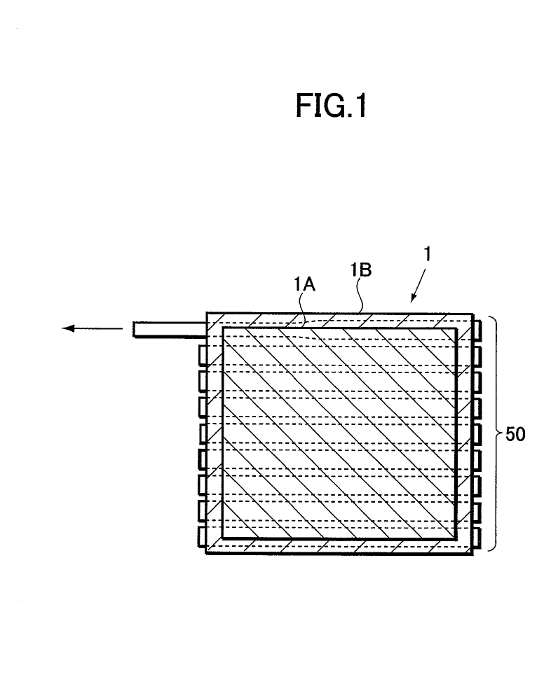

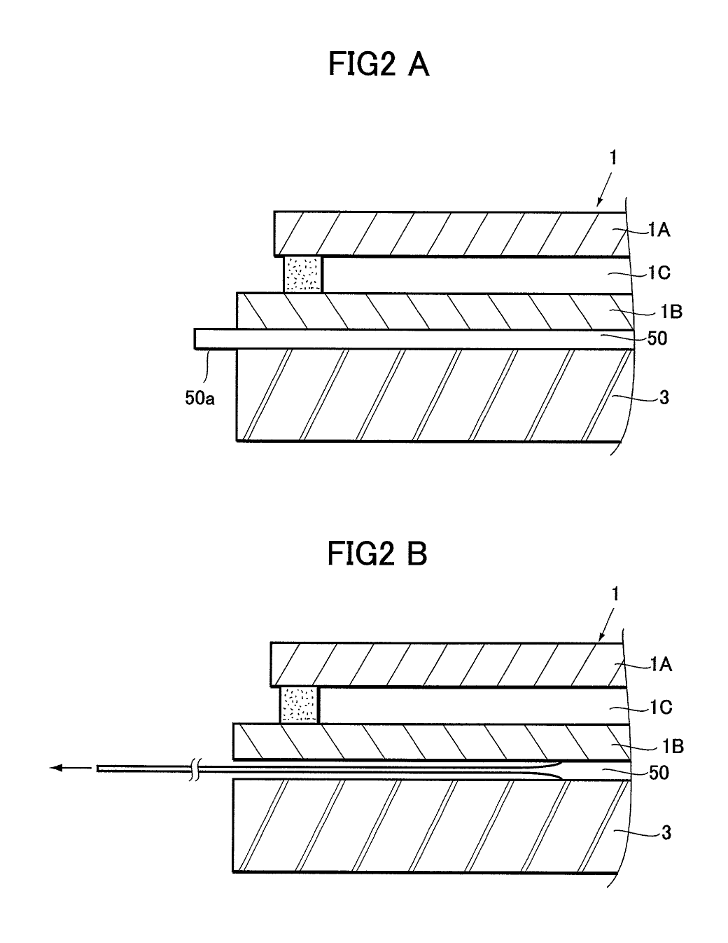

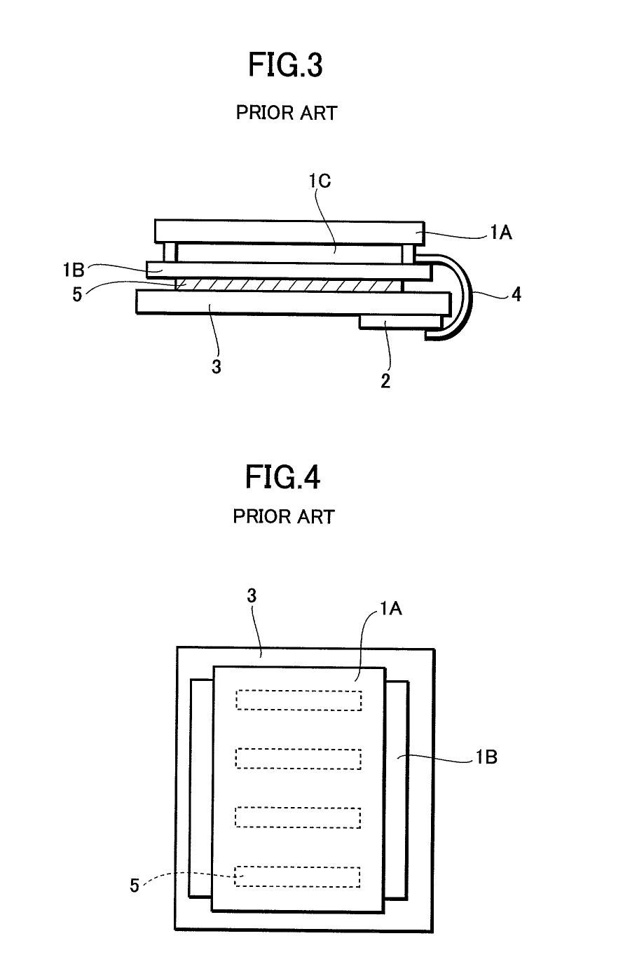

FIG. 1 and FIGS. 2A and 2B are explanatory diagrams for illustrating the construction of a display apparatus according to a preferred embodiment of the present invention, in which FIG. 1 is a plan view and FIGS. 2A and 2B are side views. The illustrated display apparatus has a PDP (Plasma Display Panel) 1 which is configured such that a front glass substrate 1A and a back glass substrate 1B are bonded together with a discharge space 1C between. To the back surface of the PDP 1 a chassis 3 is attached with a plurality of double-faced adhesive tapes 50 interposed therebetween. The chassis 3 is made of a metal such as aluminum, and so configured as to cover at least the entire back surface of the back glass substrate 1B. The chassis 3 has an entirely flat surface to which the PDP 1 is attached, and an opposite surface on which radiation fins made up of thin plates are provided (not shown). Further, although not shown in the drawings, mounted on the chassis 3 is a circuit board including a driving circuit for driving the PDP 1 as in the above-described prior art. The circuit board is electrically connected to the PDP 1 through a flexible cable.

In such a display apparatus, the double-faced adhesive tape 50 for attaching the chassis 3 to the back surface of the PDP 1 is a strip-like tape having a predetermined width and a length consistent with the lateral width of the PDP 1. A plurality of such double-faced adhesive tapes 50 are arranged in parallel in the width direction. Further, in the embodiment, a length of the double-faced adhesive tape 50 is set to be slightly longer than the lateral width of the PDP 1 such that an end portion 50a of the double-faced adhesive tape 50 protrudes outwards beyond the ends of the PDP 1 and chassis 3.

The double-faced adhesive tape 50 in the above embodiment includes a base material with a high elasticity, on both surfaces of which adhesive layers are provided respectively. The base material consists of a polymer foam layer or a polymer film layer, and a suitable base material has Young's modulus of thousands psi and preferably a breaking elongation rate of more than or equal to 300 percent. For the polymer foam layer or polymer film layer, an acrylic polymer, polyurethane, or a combination of both is particularly suitable. The above polymer may be a mixture containing plastic and elastomeric materials, e.g.: polypropylene and polyethylene; polyurethane and polyolefin; polyurethane and polycarbonate; polyurethane and polyester. In fact, the adhesive layer may be selected in relation to a peel force as will be described later, but when the above base material is used, a suitable adhesive layer is required to have a shear adhesive strength of equal to or smaller than 60 N/cm².

In the display apparatus configured as described above, in order to detach the PDP 1 from the chassis 3, as illustrated in FIG. 1, one end of one of the plurality of the double-faced adhesive tapes 50 is held and the tape is pulled in the longitudinal direction as represented by the arrow. Upon pulling the double-faced adhesive tape consisting of the high-elasticity base material as described above in the longitudinal direction, a high degree of strain will be caused in the longitudinal direction, and therefore another strain in the width direction (lateral strain) will be caused corresponding to the amount of the result of multiplying the strain in the longitudinal direction (longitudinal strain) by the Poisson ratio determined by the characteristics of the base material (see FIG. 1). Further, as illustrated in FIG. 2B, a similar strain is caused also in the thickness direction. Those strains in the width and thickness directions can act as a peel force against the adhesion strength of the adhesive layer. In other words, when the peel force caused by the strains in the width and thickness directions is set to be larger than the shear adhesive strength which is the total maximum adhesion of the double-faced adhesive tape, it is possible to pull the double-faced adhesive tape from between the PDP 1 and the chassis 3 by an extremely simple operation of pulling an end of the double-faced adhesive tape. As may be understood from the above description, the selection of a base material having a high Poisson ratio is effective for obtaining an adequate peel force.

Further, the base material of the double-faced adhesive tape 50 having a tensile strength higher than the tensile force required for peeling allows the tape to be pulled out from between the PDP 1 and the chassis 3 without breaking. Pulling the double-faced adhesive tape 50 at the same time from both ends, not only from one end of the tape, can ensure a smoother peeling operation. In fact, the same operation for the aforementioned one of the double-faced adhesive tapes 50 can also be performed on all the other double-faced adhesive tapes 50, thereby easily separating the PDP 1 from the chassis 3.

In the above embodiment, both ends of the double-faced adhesive tape 50 protrude in either direction beyond the ends of the PDP 1 and chassis 3, but it is also possible that only one of the ends is caused to protrude. If the PDP 1 and the chassis 3 differ from each other in lateral width, the end of the double-faced adhesive tape may be exposed from the end of the PDP 1 or chassis 3, whichever has the smaller lateral width. Such a protrusion and exposure of the end of the double-faced adhesive tape provides a holding margin for pulling.

According to the above-described embodiment of the present invention, without using any additional members, only by means of a selection of the physical properties of a double-faced adhesive tape which has been conventionally employed, a plasma display apparatus may be made more adapted for its recycling. Further, since the peeling operation does not need any special tool and apparatus, the recycling cost can be minimized. The simple and effortless peeling operation in which an end of the double-faced adhesive tape is only pulled can provide a high efficiency of working and causes no damage to a PDP and a chassis when the tape is peeled.

Still further, a dense arrangement of a plurality of the double-faced adhesive tapes prevents an impairment of the dissipation property of the panel and achieves a reliable attachment. A glass edge portion of the PDP on which thermal stress is concentrated serves as an electrode junction, and therefore it has not been used as a mating surface with the chassis (due to some problems associated with re-work and the like) until now. However, the provision of the easy re-peeling operation allows the chassis to be bonded to the PDP from end to end, while at the same time alleviating an undesired thermal stress.

The aforementioned embodiment illustrates an example of using the PDP as the display panel, but the present invention is not limited thereto and can applies to other flat display panels such as an organic EL display, a liquid crystal display and an EFD.

Further, the present invention having the construction as described above provides an easy peeling operation, while at the same time ensuring an adhesion area required between a display panel and a chassis, which allows a disassembling operation for recycling and a parts replacement operation to be simplified.

The terms and description used herein are set forth by way of illustration only and are not meant as limitations. Those skilled in the art will recognize that numerous variations are possible within the spirit and scope of the invention as defined in the following claims.

What is claimed is:

1. A display apparatus, comprising:
a display panel;
a chassis; and
a plurality of double-faced adhesive tapes interposed between and adhering to the back surface of the display panel and the chassis for attaching the chassis to the display panel,
wherein each of the double-faced adhesive tapes has an adhesive strength smaller than a peel force produced by a strain in its width direction which is caused by a tension in its longitudinal direction.

2. A display apparatus according to claim 1, wherein said double-faced adhesive tape has a shear adhesive strength of smaller than or equal to 60 N/cm².

3. A display apparatus according to claim 3, wherein said double-faced adhesive tape consists of a base material having a breaking elongation rate of more than or equal to 300 percent.

4. A display apparatus according to claim 1, wherein said double-faced adhesive tape has an end protruding outwardly beyond ends of both said display panel and said chassis or beyond an end of one of said display panel and said chassis.
